(19) United States
(12) Patent Application Publication
(10) Pub. No.: US 2001/0038509 A1
(43) Pub. Date: Nov. 8, 2001

(54) Undersized DML cover for a disc drive

(75) Inventors: Paul Daniel Lofstrom, Roseville, MN (US); David D. Koester, Chanhassen, MN (US)

Correspondence Address: SCHWEGMAN, LUNDBERG, WOESSNER & KLUTH, P.O. BOX 2938, MINNEAPOLIS, MN, 55402, US

(73) Assignee: Seagate Technology LLC

(21) Appl. No.: 09/836,311

(22) Filed: Apr. 17, 2001

Related U.S. Application Data
(60) Provisional application No. 60/198,165, filed on Apr. 17, 2000.

(51) Int. Cl. G11B 17/02

(52) U.S. Cl. 360/97.01

(57) ABSTRACT

A disc drive system includes a base with sidewalls, a spindle attached to the base, and at least one disc attached to the spindle. A cover is also included for attaching to the base. The cover and the base form a disc enclosure which encloses the at least one disc, a portion of the spindle, and the actuator assembly. The disc drive system also includes a cover for attenuating acoustical emissions produced by the spindle, the at least one disc, and the actuator assembly. The cover has a surface area which is smaller than the area of the baseplate within the sidewalls of the base. A plurality of closely spaced fasteners are used to attach the cover to the base.

### RELATED APPLICATIONS

This application claims the benefit under 35 U.S.C. 119(e) of U.S. Provisional Application Ser. No. 60/198,165 filed Apr. 17, 2000.

### FIELD OF THE INVENTION

The present invention relates to the field of mass-storage devices. More particularly, this invention relates to a method and apparatus for reducing acoustic noise from disc drives.

### BACKGROUND OF THE INVENTION

Devices that store data are key components of any computer system. Computer systems have many different devices where data can be stored. One common device for storing massive amounts of computer data is a disc drive. The basic parts of a disc drive are a disc assembly having at least one disc that is rotated, an actuator that moves a transducer to various locations over the rotating disc, and circuitry that is used to write and/or read data to and from the disc via the transducer. The disc drive also includes circuitry for encoding data so that it can be successfully retrieved from and written to the disc surface. A microprocessor controls most of the operations of the disc drive, in addition to passing the data back to the requesting computer and taking data from a requesting computer for storing to the disc.

The disc drive includes a transducer head for writing data onto circular or spiral tracks in a magnetic layer the disc surfaces and for reading the data from the magnetic layer. In some drives, the transducer includes an electrically driven coil (or “write head”) that provides a magnetic field for writing data, and a magneto-resistive (MR) element (or “read head”) that detects changes in the magnetic field along the tracks for reading data.

The transducer is typically placed on a small ceramic block, also referred to as a slider, that is aerodynamically designed so that it flies over the disc. The slider is passed over the disc in a transducing relationship with the disc. Most sliders have an air-bearing surface (“ABS”) which includes rails and a cavity between the rails. When the disc rotates, air is dragged between the rails and the disc surface causing pressure, which forces the head away from the disc. At the same time, the air rushing past the cavity or depression in the air bearing surface produces a negative pressure area. The negative pressure or suction counteracts the pressure produced at the rails. The slider is also attached to a load spring which produces a force on the slider directed toward the disc surface. The various forces equilibrate so the slider flies over the surface of the disc at a particular desired fly height. The fly height is the distance between the disc surface and the transducing head, which is typically the thickness of the air lubrication film. This film eliminates the friction and resulting wear that would occur if the transducing head and disc were in mechanical contact during disc rotation. In some disc drives, the slider passes through a layer of lubricant rather than flying over the surface of the disc.

Information representative of data is stored on the surface of the storage disc. Disc-drive systems read and write information stored on tracks on storage discs. Transducers, in the form of read/write heads attached to the sliders, located on both sides of the storage disc, read and write information on the storage discs when the transducers are accurately positioned over one of the designated tracks on the surface of the storage disc. The transducer is also said to be moved to a target track. As the storage disc spins and the read/write head is accurately positioned above a target track, the read/write head can store data onto a track by writing information representative of data onto the storage disc. Similarly, reading data on a storage disc is accomplished by positioning the read/write head above a target track and reading the stored material on the storage disc. To write on or read from different tracks, the read/write head is moved radially across the tracks to a selected target track. The data is divided or grouped together on the tracks. In some disc drives, the tracks are a multiplicity of concentric circular tracks. In other disc drives, a continuous spiral is one track on one side of a disc drive. Servo feedback information is used to accurately locate the transducer. The actuator assembly is moved to the required position and held very accurately during a read or write operation using the servo information.

When the disc assembly is rotated at high speed, the air adjacent to the spinning disc or discs is caused to move as well. This moving air moves between the rotating disc and the read/write transducer, creating an air bearing, and advantageously causing the transducer to “fly” over the disc surface.

An operating disc drive can emit relatively large amounts of acoustic noise generated by vibrations of the disc drive cover caused by the spinning motions of the spindle and seek and track following motions of the actuator. The spindle and actuator movements create forces that act on the structure of the disc drive. These forces eventually find a path to the device enclosure. When the forces reach the device enclosure, the forces are converted into displacements which in turn create pressure waves in the surrounding air which are perceived as acoustic noise to the human ear.

The actuator assembly moves in response to energizing a voice coil motor to move the actuator assembly about a pivot axis, thereby swinging each of the arms associated with the actuator assembly, the load springs, and associated read/write head over the associated disc surface. When moved in this manner during normal operation, the assembled load springs and associated read/write head tend to vibrate at some frequencies. The spindle motor, and rapidly spinning the discs, contribute additional vibration. Vibration from the spindle motor and voice coil motor actions may be transmitted to the disc drive housing through the pivot and spindle journals. The resulting vibration in the housing causes radiation of acoustic noise, especially from the cover. Such acoustic noise may be annoying and may suggest poor quality to the user.

The device enclosure actually acts like a speaker for the internal forces created by the spindle and actuator movement. The dynamics of the device enclosure, such as the natural modes of vibration, act as mechanical amplifiers for the forces generated inside the drive. It has been found that the shape of the acoustic spectrum in the frequency domain is similar to the shape of the mechanical transfer function of the device enclosure. If it were possible to make the device enclosure infinitely stiff then no displacements could be created that would be manifested as acoustic noise.

In addition to being annoying and possibly suggesting poor quality to the user, high acoustic emissions from disc drives tend to reduce the comfort level for a particular computing environment. As a result, acoustic noise emanating from a disc drive is a critical performance factor that is usually tightly specified to be below a maximum level. As part of the quality assurances practices when manufacturing disc drives, the drives are tested in an acoustic tester to determine the amount of noise emanating from the device. Drives that emit noise above a maximum threshold need to be re-worked to be in compliance with the requirements.

Government agencies throughout the world are now requiring that the decibel level of average sound energy emanating from office equipment be substantially reduced. Computer manufacturers are also placing acoustic emission standards on disc drive manufacturers. Manufacturers of disc drives have also long recognized that certain improvements for data storage performance in disc drives, namely, to increase disc rotation velocity and to increase head actuator movement frequency, contribute to unwanted acoustic noise. There is a marked decrease in human sensitivity to acoustic noise below about 200 Hz and above about 6000 Hz. Thus, it is clearly advantageous to attenuate acoustic noise radiated from disc drives in the frequency range from about 200 Hz to about 4000 Hz.

Several methods to reduce the intensity of unwanted acoustic noise have been attempted. Among the several methods are the use of external dampening techniques for the entire disc drive. For example, mechanically isolating the cover of a disc drive from the mechanical reinforcement structure with a continuous airspace. Many designers believe that most of the unwanted acoustic frequencies emanate from a “drum-like” top cover and from the base plate of the disc drive. Some designers have made strides in addressing the acoustic frequencies that escape from the top cover. The designers use cover dampeners and adhesives with inherent dampening properties on the cover. Other designers have attempted to completely surround the exterior of the disc drive with sound deadening material. Still other designers have attempted to completely isolate the spindle from the base in order to reduce the unwanted acoustic emissions at multiple frequencies. Such spindle isolation conventionally includes indirect attachment of the spindle to the base. Many environments where disc drives are used are sensitive to the amount of acoustic emissions (or noise) coming from an operating disc drive.

Disc drives are now being contemplated for use in home entertainment applications. Use of disc drives is now contemplated for video and television. One application of disc drives includes adding them to home set top boxes. Still others use disc drives to capture images from television for replay at a later time. One such system is the TiVo System from Phillips Corporation. Users in the home entertainment area are especially sensitive to acoustic noise, since noises seem more pronounced during quiet scenes of a movie or when background music is softly played.

Therefore, it is desirable to reduce such acoustic noise. What is also needed is a simple solution that is not prohibitively costly and which introduces few, if any, new parts to the disc drive. What is needed is a method and apparatus to substantially reduce unwanted acoustic emissions at or near the spindle. Also needed is an inexpensive method and apparatus which only slightly increases the complexity of the manufacturing processes needed to manufacture the drive. The solution also must not increase the size of the disc drive system. Clearly, there is a need for a solution to reduce or eliminate the vibration energy transferred to the cover and housing from the voice coil and spindle motors. There is also need for a solution which minimizes re-working of disc drives.

### SUMMARY OF THE INVENTION

A disc drive includes a base plate and a spindle attached to the base plate. In addition, at least one disc is attached to the spindle and the spindle is adapted to rotate with respect to the base plate. The disc drive also includes a cover for attaching to the base plate. The cover and the base plate form a disc enclosure which encloses the at least one disc and a portion of the spindle. An apparatus for reducing actuator noise in a disc-drive system includes providing a cover having a reduced surface area.

One embodiment provides a disc drive having a base. The base includes a footprint associated with the outer periphery of the base, a set of sidewalls, and sidewall extensions. The sidewall extensions extend inwardly from the outer periphery of the base. A spindle is attached to the base. At least one disc is attached to the spindle. The spindle rotates with respect to the base. A cover attaches to the sidewall extensions of the base. The cover has a footprint which is less than the footprint associated with the base. The cover and the base plate form a disc enclosure which encloses the disc of the disc drive. The footprint of the cover is within the footprint of the base. In some embodiments the cover includes a laminate material. The cover includes a plurality of fastener openings associated with each edge of the cover. The fastener openings are positioned along the edge of the cover within 2 inches of one another or may be even more closely spaced along the edge of the cover within 1.5 inches of one another. In some embodiments, the outer periphery of the disc does not extend to the sidewalls of the base. The disc drive and the disc have form factors associated therewith and the form factor of the discs may be smaller than the form factor of the disc drive. For example, the disc drive may include a disc associated with a 2.5 inch form factor disc drive within a base having a form factor associated with a 3.5 inch disc drive. The sidewall extensions which extend inwardly from the outer periphery of the base may also include a recess adapted to receive the cover. The sidewall extensions also have openings therein for receiving fasteners.

A disc drive having a selected form factor includes a baseplate which includes sidewalls. The baseplate has a first major surface with a first surface area. The disc drive also includes a cover having a second major surface. The cover is adapted to fit onto a disc drive of the selected form factor. The cover has an outer periphery which fits within the surface area of the first major surface. The surface area of the second major surface is less than the surface area of the first major surface. The cover includes openings adapted to receive fasteners, wherein the openings are spaced less than two inches apart about the outer periphery of the cover. In some instances, the openings are spaced less than 1.5 inches apart about the outer periphery of the cover. The base and the cover form a disc enclosure. The first major surface of the base is positioned within the disc enclosure.

Most generally, a disc drive system includes a base plate having an outer periphery, a spindle attached to the base plate, and at least one disc attached to the spindle. The spindle is adapted to rotate with respect to the base. An actuator assembly is attached to the base. The actuator assembly is adapted to rotate with respect to the base. A cover device attaches to the base plate. The cover device lessening acoustical emissions produced by the disc drive.

Advantageously, the cover device has a surface area which is smaller than the base. The surface area of the cover device is smaller than the surface area of the base which is within the sidewalls of the base. The cover is also attached along its outer periphery with a plurality of relatively closely spaced fasteners. The smaller surface area and the relatively closely spaced fasteners increase the resonant frequency of the cover. The disc drive assembly will convert some amount of energy from the disc drive into acoustic energy. The inventive cover which resonates at a higher frequency will produce less noise since for a given amount of energy, the amplitude of the waves produced by the cover will be lower given the higher resonate frequency of the cover. Accordingly, the noise from a cover having a surface area less than the form factor of the base can be reduced significantly when compared to designs where the surface area of the cover has about the same area as the base. For example, a cover having a surface area less than that associated with a 3.5 inch form factor base can have a reduction in the amount of noise by 1.9 dBA or more.

### BRIEF DESCRIPTION OF THE DRAWINGS

FIG. 1 is an exploded view of a disc drive with a multiple disc stack and a ramp assembly for loading and unloading transducers to and from the surfaces of the discs.

FIG. 2 is a schematic cut away view of an assembled disc drive incorporating the undersized DML cover of the present invention.

FIG. 3 is an isometric view of an undersized DML cover associated with one embodiment of the invention.

FIG. 4 is a perspective illustration of an embodiment of a disc drive assembly shown with a cover including multiple damped cover plates exploded from a base chassis of the disc drive assembly.

FIG. 5 is a perspective illustration of the disc drive assembly shown in FIG. 4 with the cover connected to the base chassis of the disc drive assembly.

FIG. 6 is an exploded illustration of an embodiment of the cover including multiple damped cover plates as illustrated in FIG. 5.

FIG. 7 is a cross-sectional view taken along line 7-7 of FIG. 4.

FIG. 8 is a flowchart illustrating an embodiment for damping vibration to reduce acoustic noise.

FIG. 9 is a diagram of an information handling system.

### DESCRIPTION OF THE PREFERRED EMBODIMENT

In the following detailed description of the preferred embodiments, reference is made to the accompanying drawings which form a part hereof, and in which are shown, by way of illustration, specific embodiments in which the invention may be practiced. It is to be understood that other embodiments may be utilized and structural changes may be made without departing from the scope of the present invention.

The invention described in this application is useful for all types of disc drives, including hard-disc drives, ZIP drives, floppy-disc drives, and any other type of drives, systems of drives (such as a “redundant array of inexpensive/independent disc drives,” or RAID, configuration) or other devices, where a disc assembly is rotated within a housing.

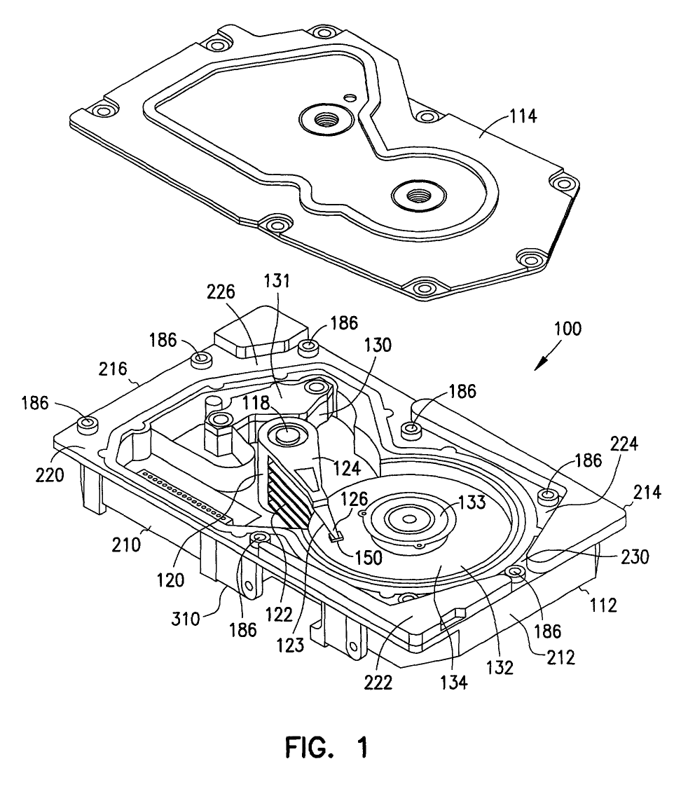

The invention described in this application is useful with many electrical and mechanical configurations of disc drives having either rotary or linear actuation. In addition, the invention is also useful in all types of disc drives including hard disc drives, zip drives, floppy disc drives and any other type of drives where providing a low-noise current source for the transducer may be desirable. FIG. 1 is an exploded view of one embodiment of the present invention, this embodiment showing one type of a disc drive 100 having a rotary actuator. The disc drive 100 includes a housing or base 112, and a cover 114. The base 112 and cover 114 form a disc enclosure. Rotatably attached to the base 112 on an actuator shaft 118 is an actuator assembly 120. The actuator assembly 120 includes a comb-like structure 122 having a plurality of arms 123. Attached to the separate arms 123 on the comb 122, are load beams or load springs 124. Load beams or load springs are also referred to as suspensions. Attached at the end of each load spring 124 is a slider 126 which carries a magnetic transducer 150. In some embodiments, transducer 150 includes a electromagnetic coil write head and a magneto-resistive read head. The slider 126 with the transducer 150 form what is many times called the head. It should be noted that many sliders have one transducer 150 and that is what is shown in the figures. It should also be noted that this invention is equally applicable to sliders having more than one transducer, such as what is referred to as an MR or magneto resistive head in which one transducer 150 is generally used for reading and another is generally used for writing. On the end of the actuator assembly 120 opposite the load springs 124 and the sliders 126 is a voice coil 128.

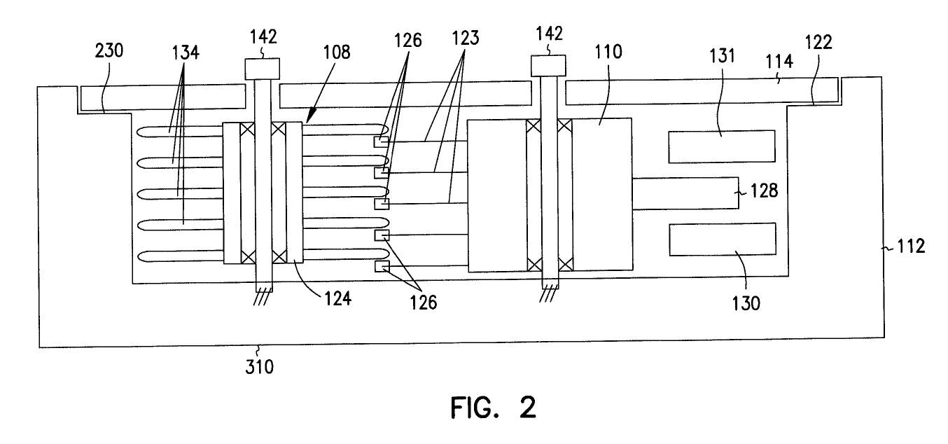

Attached within the base 112 is a first magnet 130 and a second magnet 131 (shown schematically in FIG. 2). As shown in FIG. 1, the second magnet 131 is more closely positioned near the cover 114. The first and second magnets 130, 131, and the voice coil 128 are the key components of a voice coil motor which applies a force to the actuator assembly 120 to rotate it about the actuator shaft 118. Also mounted to the base 112 is a spindle motor. The spindle motor includes a rotating portion called spindle hub 133. In this particular disc drive, the spindle motor is within hub 133. In FIG. 1, a number of discs 134 (one or more; four are shown) are attached to the spindle hub 133 to form disc assembly 132. In other disc drives, a single disc or a different number of discs may be attached to the hub. The invention described herein is equally applicable to disc drives which have a plurality of discs as well as disc drives that have a single disc. The invention described herein is also equally applicable to disc drives with spindle motors which are within the hub 133 or under the hub.

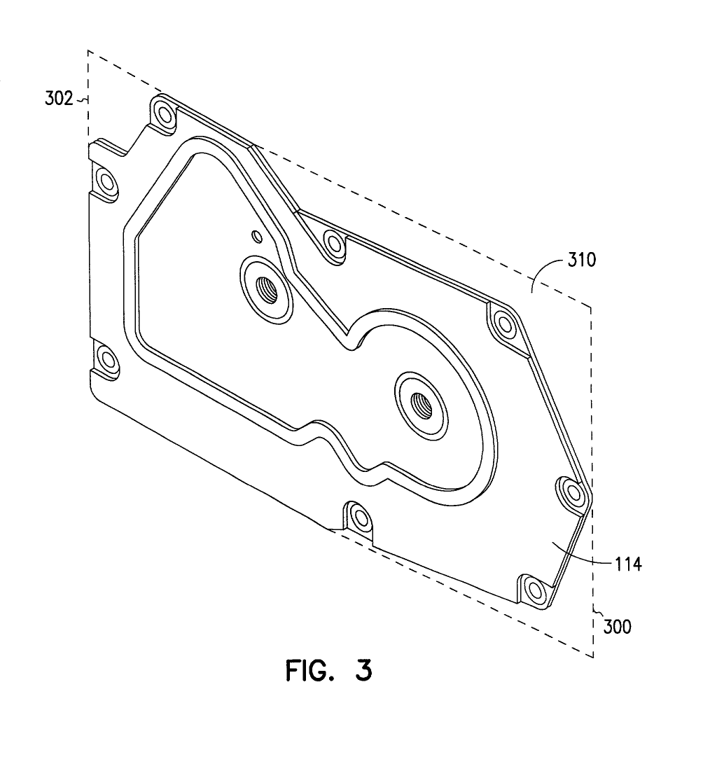

The base or deck 112 includes sidewalls 210, 212, 214 and 216. Inboard from the sidewalls 210, 212, 214 and 216 are sidewall extensions 220, 222, 224 and 226. The sidewall extensions can also be termed as wings. The sidewall extensions 220, 222, 224 and 226 extend inward from the outer sidewalls 210, 212, 214 and 216. The sidewall extensions 220, 222, 224 and 226 include connection points or openings 188. The openings are fairly closely spaced. In some embodiments, the openings are threaded for receiving threaded fasteners and are positioned at intervals which are 2 inches or less and in other embodiments, the threaded openings are positioned at 1½ inches or less. The side extensions 220, 222, 224 and 226 include a recess 230 into which the cover 114 fits. Of note is that the cover 114 is reduced when compared to the footprint of the base or deck 112. In other words, the top portion of the base or deck 112 has an outer perimeter which is defined as a rectangular outer perimeter which defines the footprint of the disc drive 100. The cover 114 includes portions which are located within the footprint of the disc drive 100. This is also illustrated in FIG. 3 which is discussed below. In addition, it should be noted that the disc drive 100 is of a first form factor and the discs 134 within the disc drive are of a second form factor. In this particular disc drive, the discs 134 are generally found in a 2½ inch form factor drive. In other words, the discs 134 are close to 2.5 inches in diameter. The outside form factor of the disc drive 100, without the sidewall extensions 224, 222, 220 and 226, would generally fit discs of a 3½ inch form factor which are, in fact, closer to 3.75 inches in diameter. The sidewall extensions 224, 222, 220 and 226 allow for an undersized cover 114 to be placed upon the deck 112. The recess 230 in the deck, and specifically in the sidewall extensions 220, 222, 224 and 226, is sized to accommodate the cover 114.

As shown schematically in FIG. 2, a spindle assembly 108 includes a rotating hub portion 133 and a spindle shaft 126 fixedly coupled to the base chassis 112 and cover 114. Hub portion 133 rotates about spindle shaft 126 via operation of a spindle motor (not shown). Discs 134 are supported on the spindle hub 133 for rotation for operation of the disc drive assembly. The actuator assembly 120 includes a plurality of actuator arms 123 supporting the sliders 126 and transducers 150. The actuator assembly 120 rotates about an actuator shaft 142 similarly fixedly secured relative to the base chassis 112 and cover 114 as illustrated schematically. Rotation of the spindle hub 133 and actuator assembly 120 imparts vibration to the cover 114 via the fixed connection between the shafts 126, 132 of the spindle assembly 108 and actuator assembly 120, respectively and the cover 114. Vibration of the cover 114 at different frequencies can create undesirable acoustic noise. The present invention relates to a cover designed to dampen vibration to reduce acoustic noise.

FIG. 3 is an isometric view of the undersized DML cover 114 associated with one embodiment of this invention. Also shown in FIG. 3 is the footprint associated with one of the form factors of a disc drive. In this particular embodiment, the cover 114 is shown within the perimeter of a 3.5 inch form factor footprint. The footprint is shown by dotted lines 300 and dotted lines 302. Dotted lines 300 show the rectangular footprint around three sides of the cover 114 and dotted lines 302 show the completion of the form factor around one other corner of the cover 114. As is clearly evident from FIG. 3, the cover 114 fits within the outer periphery or footprint of the standard form factor associated with the disc drive 100. The sidewall extensions 220, 222, 224 and 226 allow for the reduced size cover 114. The reduced size cover allows for shorter dimensions to be spanned when compared to a cover that would extend to the outer periphery of the footprint of the disc drive 100. The cover 114 also includes openings which correspond to the openings 186 in the base or deck 112. The openings in the cover are closely spaced such that the cover is restrained so that for a given input of acoustic power that might be transmitted to the cover 114, there will be a higher frequency associated with the resonance of the cover 114. With a higher frequency of resonance for a given amount of power, there will be a lower amplitude and, therefore, less noise output from the cover 114. This particular arrangement will provide for reduced noise.

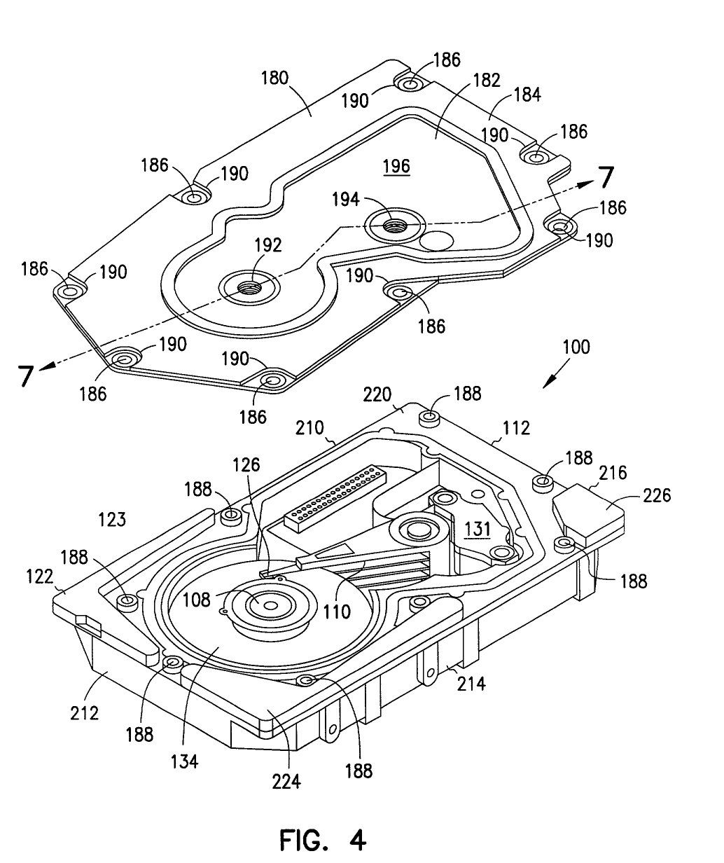

It should be noted that the cover 114 has a reduced footprint on at least a portion of three sides, or three edges of the cover 114 when compared to the form factor of the disc drive to which it is attached. In the particular embodiment shown, the footprint of the cover 114 compared to the footprint of the base 112 is reduced on portions of four sides or four edges of the cover 114. It should be noted that any construction which provides for reduced surface area and multiple points closely spaced for connecting the cover to the deck or base 112 will provide for a higher resonant frequency and lower amplitude of noise and, therefore, lower overall noise output from the cover 114. In this particular embodiment, a special cover which includes multiple damped cover plate is used. It should be noted that although the multiple damped cover plate is discussed below with reference to FIGS. 4-8, the invention is not limited to a cover plate 114 which includes this particular construction. A cover 114 of any construction having a reduced footprint is within the scope of this invention.

It should be noted from FIG. 3 that the base plate 112 has a first major surface 300 that is compared to the surface area of the cover 114 in FIG. 3 since the footprint markings 310, 312 represent the surface area of the first major surface 300 of the disc drive. The cover 114 has a second major surface 320. The surface area of the second major surface 320 of the cover 114 is smaller than the surface area of the first major surface 300.

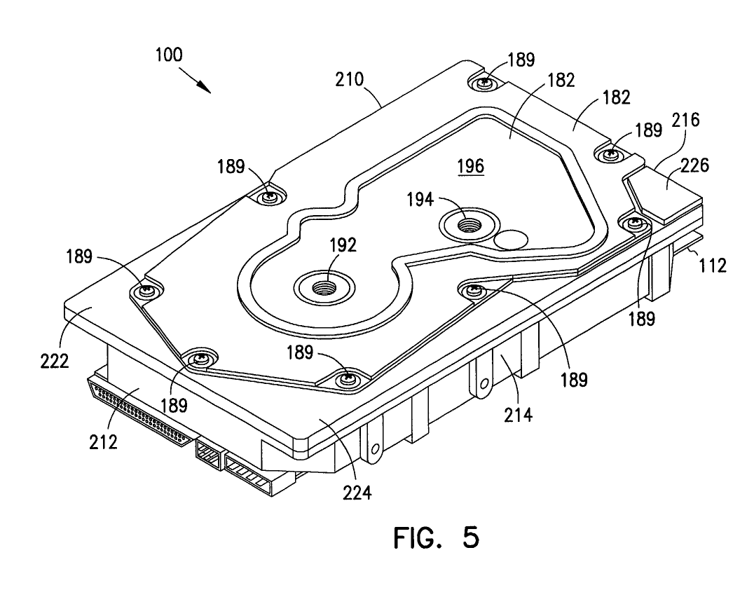

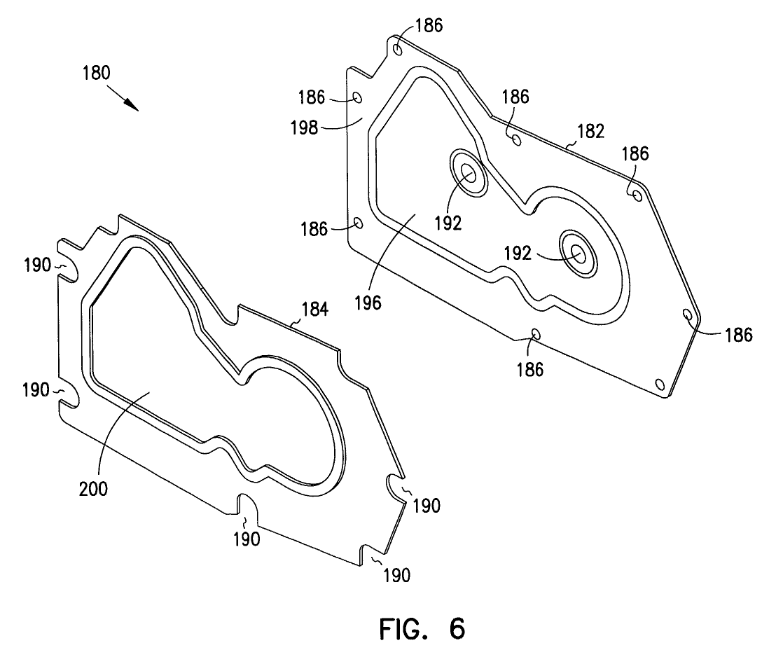

FIGS. 4-6 illustrate an embodiment of a cover 180 including multiple damped cover plates for a disc drive assembly 100. Cover assembly 180 is shown exploded from base chassis 112 in FIG. 4 and is shown connected to deck or base 112 in FIG. 5. As shown, cover assembly 180 includes multiple cover plates 182 and 184. Cover plate 182 is a fixed cover plate and includes fastener openings 186 to connect the cover plate 182 and cover 180 to base or deck 112. Fastener openings 186 on cover plate 182 align with fastener openings 188 on deck or base 112. Fasteners 189 shown in FIG. 6 extend through openings 186, 188 on cover plate 182 into the deck or base 112 to connect cover 180 to the base 112 as shown in FIG. 6.

Cover plate 184 is connected to cover plate 182 to form a composite cover structure shown in FIG. 8. Cover plate 182 is secured to deck 112 to form the fixed cover plate. Cover plate 184 is coupled to cover plate 182 and not deck or base 112 to form a “floating cover” plate. Cover plate 184 includes a plurality of notches 190 aligned with and contoured about fastener openings 186 to allow cover plate 182 to be connected to the base 112 through fastener openings 186 without connecting cover plate 184 to the base 112. In the embodiment shown, the composite cover 180 is coupled to deck 112 so that cover plate 182 forms an inner cover plate and cover plate 184 forms an outer cover plate supported over cover plate 182. Notches 190 provides access to the fastener openings 186 on cover plate 182 to insert fasteners 189 to connect cover 180 to the base 112.

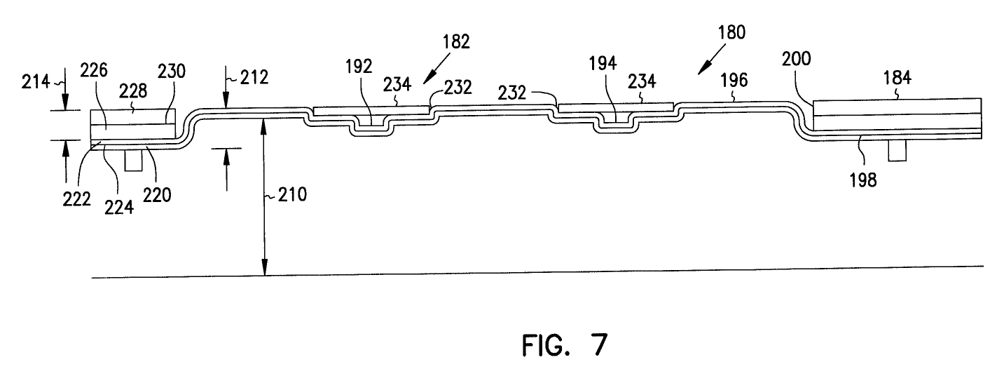

As shown in FIGS. 4-6, cover plate 182 includes fastener openings 192, 194 to secure spindle assembly 108 and actuator assembly 112 to the fixed cover plate 182. In the embodiment shown in FIGS. 7-8, fastener openings 192, 194 are formed on a raised portion 196 of plate 182 surrounded by rim portion 198 of cover plate 182. Cover plate 184 is supported on rim portion 198 of cover plate 182 and includes a cut-out portion 200. Raised portion 196 extends through cut-out portion 200. In the embodiment shown, cut-out portion 200 is contoured about raised portion 196 and provides accessibility to openings 192, 194 to fasten the spindle assembly 108 and actuator assembly 126 to fixed cover plate 182. Cover plate 184 is not connected to the spindle assembly 108 or actuator assembly 126 and provides a floating cover plate 184 not fixed or connected to the operating components connected to cover 180 is imparted to the floating cover plate 184 through the fixed cover plate 182.

As shown in FIG. 7, a height of the raised portion 196 of cover plate 182 is illustrated schematically by line 210 provides sufficient height or clearance for the operating components (spindle assembly 108 and E-block assembly 110). As illustrated, a stepped elevation 212 of the rim portion 198 to the raised portion 196 is dimensioned similar to the thickness 214 of cover plate 184 so that an upper surface of cover plate 184 is flush with the raised surface of cover plate 182 to conform to desired form factor dimension. Since cover plate 184 is supported on the rim portion 198, the raised portion 196 can be elevated a sufficient height to provide sufficient clearance for the operating components while the overall height of the composite structure does not increase the form factor dimensions of the cover 180.

In the embodiment illustrated in FIG. 8, cover plate 182 includes inner and outer 220, 222 structural layers and an intermediate damped layer 224. Cover plate 184 as shown includes inner and outer structural layers 226, 228 and an intermediate damped layer 230 to collectively provide an acoustic barrier to reduce acoustic noise. The structural layers and damped layers of cover plates 182, 184 are formed to relatively equal stiffness for optimum excitation response. Floating cover plate 184 is formed of a greater thickness than cover plate 182 to provide more concentrated mass for better inertia response. The intermediate damped layer 230 is formed of a viscoelastic material such as SCOTCHDAMP manufactured by 3M of St. Paul, Minn. Inner and outer layers 226, 228 are adhesively connected to the intermediate layer 230. In one embodiment, intermediate layer 230 includes a relatively thin adhesive layer on opposed surfaces of the intermediate layer 230 to adhesively secure inner and outer layers 226, 228 and the intermediate damped layer 230. Thus as described, force transmitted to cover plate 182 via the operating components is damped via the intermediate layer 230 to reduce noise.

As illustrated in FIG. 7, cover plate fastener openings 192, 194 for the spindle assembly 108 and E-block assembly are formed in a stepped cavity 232. The cavity 232 is recessed from an upper surface of the cover plate 182 for insertion of a seal 234 to seal fastener openings 192, 194 and cavity 106 from an external operating environment. In one embodiment, seal 234 induces an adhesive backing to secure seal 234 to cover plate 182.

FIG. 8 is a flowchart illustrating an operation embodiment. As shown, dynamic operating components are coupled to a multiple cover plate cover as illustrated by block 236 and vibration is damped by damped layers of the multiple cover plates as illustrated by block 238.

The present invention relates to a cover 140, 180 with multiple damped cover plates 140, 144 or 182, 184. The multiple damped cover plates 140, 144, 182, 184 include at least one relatively rigid structural layer and a damped layer to dampen vibration for acoustic noise control.

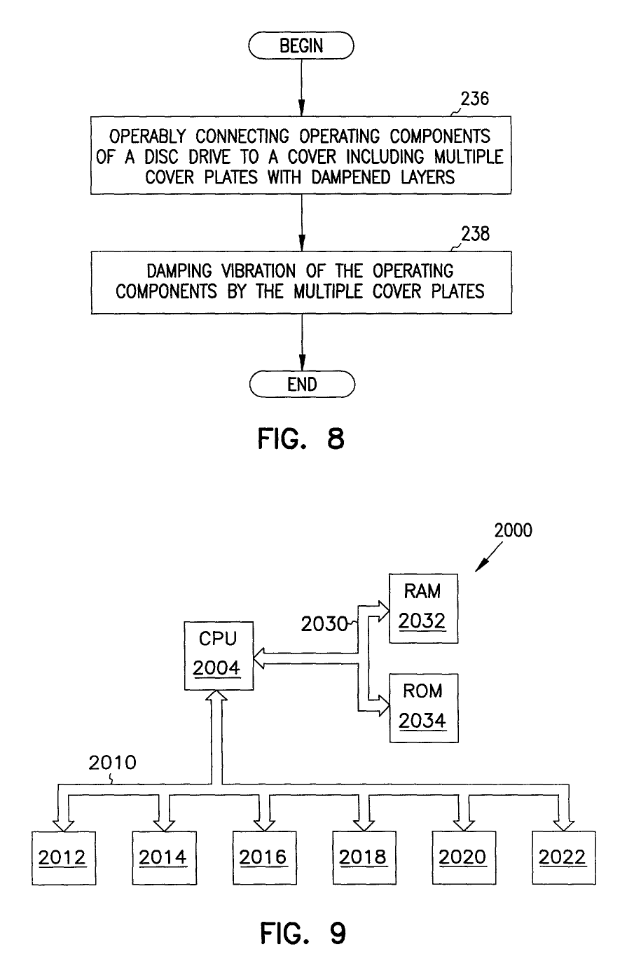

FIG. 9 is a schematic view of a computer system. Advantageously, the invention is well-suited for use in a computer system 2000. The computer system 2000 may also be called an electronic system or an information handling system and includes a central processing unit, a memory and a system bus. The information handling system includes a central processing unit 2004, a random access memory 2032, and a system bus 2030 for communicatively coupling the central processing unit 2004 and the random access memory 2032. The information handling system 2002 includes a disc drive device which includes the ramp described above. The information handling system 2002 may also include an input/output bus 2010 and several devices peripheral devices, such as 2012, 2014, 2016, 2018, 2020, and 2022 may be attached to the input output bus 2010. Peripheral devices may include hard disc drives, magneto optical drives, floppy disc drives, monitors, keyboards and other such peripherals. Any type of disc drive may use the method for loading or unloading the slider onto the disc surface as described above.

### Conclusion

Described above is a method and apparatus for isolating actuator noise in a disc-drive system. One embodiment provides a disc drive 100 having a base 112. The base 112 includes a footprint 310, 312 associated with the outer periphery of the base 112, a set of sidewalls 210, 212, 214, 216, and sidewall extensions 220, 222, 224, 226. The sidewall extensions 220, 222, 224, 226 extend inwardly from the outer periphery of the base 112. A spindle 108 is attached to the base 112. At least one disc 134 is attached to the spindle. The spindle 108 rotates with respect to the base 112. A cover 114, 180 attaches to the sidewall extensions 220, 222, 224, 226 of the base 112. The cover 114, 180 has a footprint which is less than the footprint 310, 312 associated with the base 112. The cover 114, 180 and the base 112 form a disc enclosure which encloses the disc 134 of the disc drive 100. The footprint of the cover 114, 180 is within the footprint 310, 312 of the base 112. In some embodiments the cover 114, 180 includes a laminate material. The cover includes a plurality of fastener openings 186 associated with each edge of the cover 180. The fastener openings 186 are positioned along the edge of the cover 180 within 2 inches of one another or may be even more closely spaced along the edge of the cover within 1.5 inches of one another. In some embodiments, the outer periphery of the disc 134 does not extend to the sidewalls 210, 212, 214, 216 of the base 112. The disc drive 100 and the disc 134 have form factors associated therewith. The form factor of the discs 134 may be smaller than the form factor of the disc drive 100. For example, the disc drive may include a disc 134 associated with a 2.5 inch form factor disc drive 100 within a base 112 having a form factor associated with a 3.5 inch disc drive 100. The sidewall extensions 210, 212, 214, 216 which extend inwardly from the outer periphery or sidewalls 210, 212, 214, 216 of the base 112 may also include a recess 230 adapted to receive the cover 114, 180. The sidewall extensions also have openings therein for receiving fasteners.

A disc drive 100 having a selected form factor includes a baseplate 112 which includes sidewalls 210, 212, 214, 216. The baseplate 112 has a first major surface 310 with a first surface area. The disc drive also includes a cover having a second major surface 320. The cover 114, 180 is adapted to fit onto a disc drive of the selected form factor. The cover has an outer periphery which fits within the surface area of the first major surface 310. The surface area of the second major surface 320 is less than the surface area of the first major surface 310. The cover includes openings 186 adapted to receive fasteners, wherein the openings 186 are spaced less than two inches apart about the outer periphery of the cover. In some instances, the openings are spaced less than 1.5 inches apart about the outer periphery of the cover 114, 180. The base 112 and the cover 114, 180 form a disc enclosure. The first major surface 310 of the base 112 is positioned within the disc enclosure.

Most generally, a disc drive system 100 includes a base plate 112 having an outer periphery, a spindle 108 attached to the base plate 112, and at least one disc 134 attached to the spindle 108. The spindle is adapted to rotate with respect to the base 112. An actuator assembly 120 is attached to the base 112. The actuator assembly 120 is adapted to rotate with respect to the base. A cover device 180 attaches to the base plate. The cover device 180 lessens acoustical emissions produced by the disc drive 100.

Advantageously, the cover device 114, 180 has a surface area 320 which is smaller than surface area 310 of the base 112. The surface area 320 of the cover device 114, 180 is smaller than the surface area 310 of the base 112 which is within the sidewalls 210, 212, 214, 216 of the base. The cover 114, 180 is also attached along its outer periphery with a plurality of relatively closely spaced fasteners. The smaller surface area and the relatively closely spaced fasteners increase the resonant frequency of the cover. The disc drive assembly will convert some amount of energy from the disc drive into acoustic energy. The inventive cover which resonates at a higher frequency will produce less noise since for a given amount of energy, the amplitude of the waves produced by the cover will be lower given the higher resonate frequency of the cover. Accordingly, the noise from a cover having a surface area less than the form factor of the base can be reduced significantly when compared to designs where the surface area of the cover has about the same area as the base. For example, a cover having a surface area less than that associated with a 3.5 inch form factor base can have a reduction in the amount of noise by 1.9 dBA or more.

It is to be understood that the above description is intended to be illustrative, and not restrictive. Although numerous characteristics and advantages of various embodiments of the present invention have been set forth in the foregoing description, together with details of the structure and function of various embodiments, many other embodiments and changes to details will be apparent to those of skill in the art upon reviewing the above description. The scope of the invention should, therefore, be determined with reference to the appended claims, along with the full scope of equivalents to which such claims are entitled.

What is claimed is:

1. A disc drive comprising:
a base further including
a footprint associated with the outer periphery of the base;
a set of sidewalls; and
sidewall extensions which extend inwardly from the outer periphery of the base;
a spindle attached to the base;
at least one disc attached to the spindle, the spindle adapted to rotate with respect to the base plate;
a cover for attaching to the sidewall extensions of the base, the cover having a footprint which is less than the footprint associated with the base, the cover and the base plate forming a disc enclosure which encloses the at least one disc.

2. The disc drive of claim 1 wherein the footprint of the cover is within the footprint of the base.

3. The disc drive of claim 1 wherein the cover includes a laminate material.

4. The disc drive of claim 1 wherein the cover includes a plurality of fasteners associated with each edge of the cover.

5. The disc drive of claim 4 wherein the fastener openings are positioned along the edge of the cover within 2 inches of one another.

6. The disc drive of claim 4 wherein the fastener openings are positioned along the edge of the cover within 1.5 inches of one another.

7. The disc drive of claim 1 wherein the outer periphery of the at least one disc does not extend to the sidewalls of the base.

8. The disc drive of claim 1 wherein the outer periphery of the at least one disc does not extend to the sidewalls of the base and wherein the disc drive and the disc have form factors associated therewith, the form factor associated with the discs being smaller than the form factor associated with the disc drive.

9. The disc drive of claim 8 wherein the at least one disc has is a disc associated with a 2.5 inch form factor disc drive.

10. The disc drive of claim 9 wherein the and the base has a form factor for a 3.5 inch disc drive.

11. The disc drive of claim 1 wherein the sidewall extensions which extend inwardly from the outer periphery of the base include a recess adapted to receive the cover.

12. The disc drive of claim 1 wherein the sidewall extensions which extend inwardly from the outer periphery of the base include a recess adapted to receive the cover and have openings therein for receiving fasteners therein.

13. A disc drive having a selected form factor comprising:
a baseplate which includes sidewalls, the baseplate having a first major surface having a first surface area; and
a cover further comprising:
a second major surface, the cover adapted to fit onto a disc drive of the selected form factor, the cover having an outer periphery which fits within the surface area of the first major surface.

14. The disc drive of claim 13 wherein the surface area of the second major surface is less than the surface area of the first major surface.

15. The disc drive of claim 13 wherein the cover includes openings adapted to receive fasteners, wherein the openings are spaced less than two inches apart about the outer periphery of the cover.

16. The disc drive of claim 13 wherein the cover includes openings adapted to receive fasteners, wherein the openings are spaced less than 1.5 inches apart about the outer periphery of the cover.

17. The disc drive of claim 13 wherein the base and the cover form a disc enclosure, the first major surface being within the disc enclosure.

18. A disc drive system comprising:
a base plate having an outer periphery;
a spindle attached to the base plate;
at least one disc attached to the spindle, the spindle adapted to rotate with respect to the base plate;
an actuator assembly attached to the base plate, the actuator assembly adapted to rotate with respect to the base plate; and
cover means for attaching to the base plate, the cover means lessening acoustical emissions produced by the disc drive.
